(19) United States
(12) Patent Application Publication
(10) Pub. No.: US 2025/0006934 A1
(43) Pub. Date: Jan. 2, 2025

(54) ELECTRODE FOR SECONDARY BATTERY, AND SECONDARY BATTERY

(71) Applicant: MURATA MANUFACTURING CO., LTD., Kyoto (JP)

(72) Inventor: Shogo KANBE, Kyoto (JP)

(21) Appl. No.: 18/882,229

(22) Filed: Sep. 11, 2024

Related U.S. Application Data
(63) Continuation of application No. PCT/JP2023/021490, filed on Jun. 9, 2023.

(30) Foreign Application Priority Data
Jun. 27, 2022 (JP) 2022-102522

(51) Int. Cl. H01M 4/62; H01M 4/38; H01M 10/052

(52) U.S. Cl. CPC H01M 4/62; H01M 4/38; H01M 4/625; H01M 10/052

(57) ABSTRACT

A secondary battery includes a positive electrode, a negative electrode, and an electrolytic solution. The positive electrode includes a positive electrode active material and a carbon-nitrogen-containing metal compound. The positive electrode active material includes sulfur. The carbon-nitrogen-containing metal compound includes carbon, nitrogen, and a metal element as constituent elements.

### CROSS REFERENCE TO RELATED APPLICATIONS

The present application is a continuation of PCT patent application no. PCT/JP2023/021490, filed on Jun. 9, 2023, which claims priority to Japanese patent no. 2022-102522, filed on Jun. 27, 2022, the entire contents of which are incorporated herein by reference.

### BACKGROUND

The present technology relates to an electrode for a secondary battery, and to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes an electrode (an electrode for the secondary battery) and an electrolytic solution. The electrode includes an active material.

In particular, a secondary battery has been known that includes sulfur as a positive electrode active material. A configuration of the secondary battery has been considered in various ways. Specifically, the positive electrode active material includes titanium oxide (TiO₂) together with sulfur. To obtain the positive electrode active material, sulfur and titanium oxide are mixed with each other at a weight ratio of 7:3, following which the obtained mixture of sulfur and titanium oxide is heated.

### SUMMARY

The present technology relates to an electrode for a secondary battery, and to a secondary battery.

Although consideration has been given in various ways regarding a configuration of a secondary battery, a battery characteristic of the secondary battery is not sufficient yet. Accordingly, there is room for improvement in terms of the battery characteristic of the secondary battery.

It is desirable to provide an electrode for a secondary battery, and a secondary battery each of which makes it possible to achieve a superior battery characteristic.

An electrode for a secondary battery according to an embodiment of the present technology includes a positive electrode active material and a carbon-nitrogen-containing metal compound. The positive electrode active material includes sulfur. The carbon-nitrogen-containing metal compound includes carbon, nitrogen, and a metal element as constituent elements.

A secondary battery according to an embodiment of the present technology includes a positive electrode, a negative electrode, and an electrolytic solution. The positive electrode has a configuration similar to the above-described configuration of the electrode for the secondary battery according to an embodiment of the present technology.

According to the electrode for the secondary battery of an embodiment of the present technology, the electrode for the secondary battery includes the positive electrode active material and the carbon-nitrogen-containing metal compound. The positive electrode active material includes sulfur. The carbon-nitrogen-containing metal compound includes carbon, nitrogen, and the metal element as constituent elements. Use of the electrode for the secondary battery makes it possible to provide a secondary battery having a superior battery characteristic.

According to the secondary battery of an embodiment of the present technology, the secondary battery includes the positive electrode, and the positive electrode has a configuration similar to the above-described configuration of the electrode of an embodiment of the present technology. Accordingly, it is possible to achieve a superior battery characteristic according to an embodiment.

Note that effects of the present technology are not necessarily limited to those described herein and may include any of a series of effects including described below in relation to the present technology.

### BRIEF DESCRIPTION OF THE FIGURES

FIG. 1 is a perspective diagram illustrating a configuration of a secondary battery according to an embodiment of the present technology.

FIG. 2 is a sectional diagram illustrating a configuration of a battery device illustrated in FIG. 1.

FIG. 3 is a sectional diagram illustrating a configuration of a secondary battery according to an embodiment.

FIG. 4 is a block diagram illustrating a configuration of an application example of the secondary battery according to an embodiment.

FIG. 5 is a sectional diagram illustrating a configuration of a secondary battery for testing according to an embodiment.

### DETAILED DESCRIPTION

The present technology will described below in further detail including with reference to the drawings according to an embodiment.

A description is given first of a secondary battery according to an embodiment of the present technology.

Note that an electrode for a secondary battery according to an embodiment of the present technology is a part of the secondary battery described here, that is, one component of the secondary battery, and is thus described below together.

The secondary battery is a secondary battery in which a battery capacity is obtained through insertion and extraction of an electrode reactant, and includes a positive electrode, a negative electrode, and an electrolytic solution. In the secondary battery, the electrode for the secondary battery may be used as the positive electrode or the negative electrode, or may be used as each of the positive electrode and the negative electrode. Note that the electrode reactant is not particularly limited in kind.

A description is given of an example case where the electrode for the secondary battery is used as the positive electrode and the electrode reactant is lithium. The positive electrode includes a positive electrode active material into which lithium is to be inserted and from which lithium is to be extracted. The positive electrode active material includes sulfur. In this case, lithium is inserted and extracted in an ionic state.

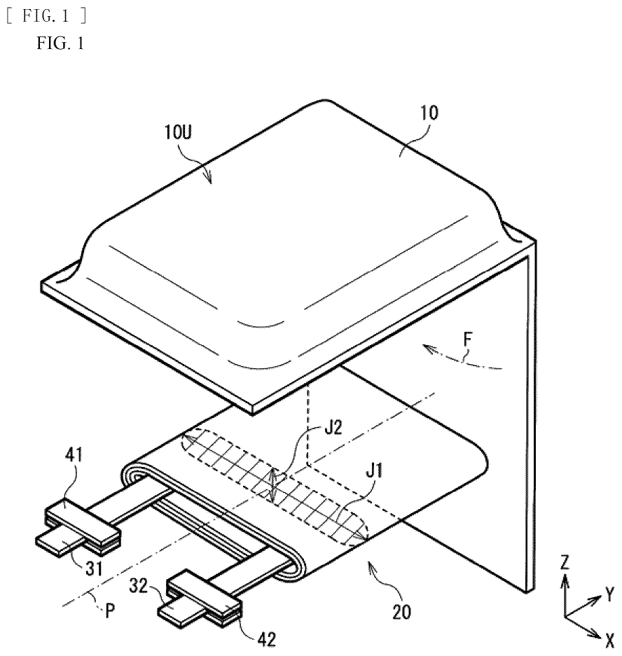

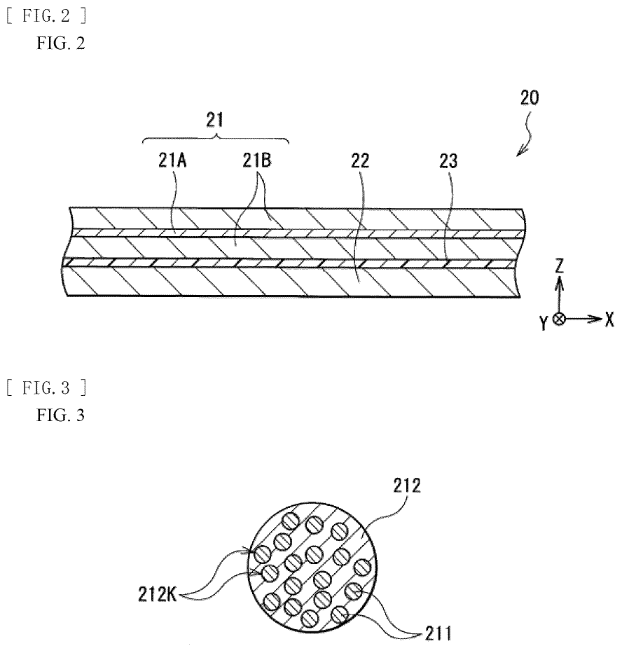

FIG. 1 illustrates a perspective configuration of the secondary battery. FIG. 2 illustrates a sectional configuration of a battery device 20 illustrated in FIG. 1. Note that FIG. 1 illustrates a state where an outer package film 10 and the battery device 20 are separated from each other, and illustrates a section of the battery device 20 along an XZ plane by a dashed line.

As illustrated in FIGS. 1 and 2, the secondary battery includes the outer package film 10, the battery device 20, a positive electrode lead 31, a negative electrode lead 32, and sealing films 41 and 42.

The secondary battery described here includes the outer package film 10 having flexibility or softness as an outer package member to contain the battery device 20 inside, as described above, and is thus a secondary battery of what is called a laminated-film type.

As illustrated in FIG. 1, the outer package film 10 has a pouch-shaped structure that is sealed in a state where the battery device 20 is contained inside the outer package film 10. The outer package film 10 thus contains a positive electrode 21, a negative electrode 22, a separator 23, and an electrolytic solution that are to be described later.

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state where the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

The battery device 20 is contained inside the outer package film 10. The battery device 20 is what is called a power generation device, and includes, as illustrated in FIGS. 1 and 2, the positive electrode 21, the negative electrode 22, the separator 23, and the electrolytic solution (not illustrated).

Here, the battery device 20 is what is called a wound electrode body. That is, the positive electrode 21 and the negative electrode 22 are wound about a winding axis P, being opposed to each other with the separator 23 interposed therebetween. As is apparent from FIG. 1, the winding axis P is a virtual axis extending in a Y-axis direction.

A three-dimensional shape of the battery device 20 is not particularly limited. Here, the battery device 20 has an elongated three-dimensional shape. Accordingly, a section of the battery device 20 intersecting the winding axis P, that is, the section of the battery device 20 along the XZ plane, has an elongated shape defined by a major axis J1 and a minor axis J2.

The major axis J1 is a virtual axis that extends in an X-axis direction and has a length larger than a length of the minor axis J2. The minor axis J2 is a virtual axis that extends in a Z-axis direction intersecting the X-axis direction and has the length smaller than the length of the major axis J1. Here, the battery device 20 has an elongated cylindrical three-dimensional shape. Thus, the section of the battery device 20 has an elongated, substantially elliptical shape.

The positive electrode 21 is an example of the electrode for the secondary battery. The positive electrode 21 includes, as illustrated in FIG. 2, a positive electrode current collector 21A and a positive electrode active material layer 21B.

The positive electrode current collector 21A has two opposed surfaces on each of which the positive electrode active material layer 21B is to be provided. The positive electrode current collector 21A supports the positive electrode active material layers 21B. The positive electrode current collector 21A includes an electrically conductive material such as a metal material. Specific examples of the electrically conductive material include aluminum.

The positive electrode active material layer 21B includes the positive electrode active material and a carbon-nitrogen-containing metal compound. The positive electrode active material and the carbon-nitrogen-containing metal compound are each in a form of particles (in what is called powder form). Thus, the positive electrode active material and the carbon-nitrogen-containing metal compound are each dispersed in the positive electrode active material layer 21B.

Here, the positive electrode active material layer 21B is provided on each of the two opposed surfaces of the positive electrode current collector 21A. Note that the positive electrode active material layer 21B may be provided only on one of the two opposed surfaces of the positive electrode current collector 21A. A method of forming the positive electrode active material layer 21B is not particularly limited, and specifically includes any one or more of methods including, without limitation, a coating method.

The positive electrode active material is a material into which lithium is to be inserted and from which lithium is to be extracted, and includes sulfur as described above.

The carbon-nitrogen-containing metal compound includes carbon, nitrogen, and a metal element as constituent elements. Only one carbon-nitrogen-containing metal compound may be used, or two or more carbon-nitrogen-containing metal compounds may be used.

More specifically, the carbon-nitrogen-containing metal compound is a compound in which carbon, nitrogen, and the metal element are bonded to each other. A form in which a carbon atom, a nitrogen atom, and a metal atom are bonded to each other in the carbon-nitrogen-containing metal compound (hereinafter, the above-described form is referred to as a “bond form”) is not particularly limited. That is, the carbon atom, the nitrogen atom, and the metal atom may be bonded to each other in any form in the carbon-nitrogen-containing metal compound as long as the carbon-nitrogen-containing metal compound includes carbon, nitrogen, and the metal element as constituent elements.

One reason why the positive electrode active material layer 21B includes the carbon-nitrogen-containing metal compound is that use efficiency of the positive electrode active material (sulfur) improves, as compared with when the positive electrode active material layer 21B includes no carbon-nitrogen-containing metal compound, which allows for an improvement in diffusibility of the electrode reactant (lithium). The use efficiency described here is what is called coulombic efficiency (charge and discharge efficiency).

In this case, in particular, when a content of the carbon-nitrogen-containing metal compound in the positive electrode active material layer 21B is set to be sufficiently small within a range that allows for an improvement in the coulombic efficiency, an energy density per weight of the positive electrode 21 is maintained even if the positive electrode active material layer 21B includes the carbon-nitrogen-containing metal compound.

Accordingly, the diffusibility of lithium in the positive electrode 21 is maintained, which reduces a decrease in a battery capacity even upon repeated charging and discharging.

The bond form of the carbon-nitrogen-containing metal compound is not particularly limited as described above, and specific examples of a bond form of carbon and nitrogen include a cyanamide (>N—C≡N) and a carbodiimide (—N═C═N—). Accordingly, specific examples of the carbon-nitrogen-containing metal compound include a metal cyanamide and a metal carbodiimide. One reason for this is that the coulombic efficiency improves sufficiently. Needless to say, the carbon-nitrogen-containing metal compound may include only either the metal cyanamide or the metal carbodiimide, or may include both the metal cyanamide and the metal carbodiimide.

The metal element is not particularly limited in kind. Accordingly, only one metal element may be used, or two or more metal elements may be used. Specific examples of the metal element include zinc (Zn), calcium (Ca), lithium (Li), sodium (Na), potassium (K), cesium (Cs), strontium (Sr), barium (Ba), magnesium (Mg), silicon (Si), titanium (Ti), lead (Pb), chromium (Cr), manganese (Mn), iron (Fe), cobalt (Co), nickel (Ni), copper (Cu), yttrium (Y), silver (Ag), cadmium (Cd), prascodymium (Pr), neodymium (Nd), samarium (Sm), curopium (Eu), gadolinium (Gd), terbium (Tb), dysprosium (Dy), holmium (Ho), erbium (Er), thulium (Tm), ytterbium (Yb), strontium zinc (SrZn), lithium aluminum (LiAl), lithium indium (LiIn), and lithium ytterbium (LiYb).

In particular, preferable examples of the metal element include zinc and calcium. A reason for this is that the coulombic efficiency further improves. Needless to say, the metal element may include only either zinc or calcium, or may include both zinc and calcium.

Accordingly, when the carbon-nitrogen-containing metal compound includes the metal cyanamide, specific examples of the metal cyanamide include zinc cyanamide and calcium cyanamide. When the carbon-nitrogen-containing metal compound includes the metal carbodiimide, specific examples of the metal carbodiimide include zinc carbodiimide and calcium carbodiimide. Note that when the carbon-nitrogen-containing metal compound includes both the metal cyanamide and the metal carbodiimide, the carbon-nitrogen-containing metal compound may include the metal cyanamide as a main component or may include the metal carbodiimide as a main component.

The content of the carbon-nitrogen-containing metal compound in the positive electrode active material layer 21B is not particularly limited, and may be set as desired. Note that, as described above, to maintain the energy density per weight of the positive electrode 21, the content of the carbon-nitrogen-containing metal compound in the positive electrode active material layer 21B is preferably sufficiently smaller than a content of the positive electrode active material in the positive electrode active material layer 21B.

Note that the positive electrode active material layer 21B may further include any one or more of other materials including, without limitation, a positive electrode binder and a positive electrode conductor.

The positive electrode conductor includes any one or more of electrically conductive materials including, without limitation, a carbon material, a metal material, and an electrically conductive polymer compound. Specific examples of the carbon material include activated carbon, graphite, carbon black, acetylene black, and Ketjen black.

The positive electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

In particular, the positive electrode active material layer 21B includes the positive electrode conductor, and the positive electrode conductor preferably includes the carbon material. One reason for this is that electrical conductivity of the positive electrode active material layer 21B improves sufficiently, which allows for a sufficient improvement in the coulombic efficiency.

As illustrated in FIG. 2, the negative electrode 22 includes a negative electrode active material. The negative electrode active material includes an alkali metal material, and the alkali metal material includes any one or more of alkali metal elements as one or more constituent elements. Note that only one alkali metal element may be included, or two or more alkali metal elements may be included. The alkali metal material may be a simple substance, an alloy, a compound, or a material including two or more thereof.

Here, the alkali metal material includes an alkali metal (what is called a simple substance of an alkali metal). One reason for this is that a sufficient battery capacity is obtainable. Note that the “simple substance” described here may include any amount of impurity. Accordingly, purity of the “simple substance” does not necessarily have to be 100%.

The alkali metal is not particularly limited in kind, and specific examples thereof include lithium, sodium, and potassium.

In particular, the alkali metal is preferably lithium as described above. One reason for this is that the coulombic efficiency further improves. The secondary battery that includes the positive electrode 21 including sulfur as the positive electrode active material, and the negative electrode 22 including lithium as the negative electrode active material is what is called a lithium-sulfur secondary battery. In this case, the negative electrode 22 may be a lithium metal plate, and may thus include a lithium metal as the negative electrode active material (the alkali metal material).

The separator 23 is an insulating porous film interposed between the positive electrode 21 and the negative electrode 22 as illustrated in FIG. 2, and allows lithium to pass therethrough in an ionic state while preventing occurrence of a short circuit caused by contact between the positive electrode 21 and the negative electrode 22. The separator 23 includes a polymer compound such as polyethylene.

The electrolytic solution is a liquid electrolyte. The positive electrode 21 and the separator 23 are each impregnated with the electrolytic solution. The electrolytic solution includes a solvent and an electrolyte salt.

The solvent includes any one or more of non-aqueous solvents (organic solvents), and the electrolytic solution including the one or more non-aqueous solvents is what is called a non-aqueous electrolytic solution.

The non-aqueous solvent includes, for example, an ester or an ether, more specifically, any one or more of a carbonic-acid-ester-based compound, a carboxylic-acid-ester-based compound, or a lactone-based compound. One reason for this is that a dissociation property of the electrolyte salt and mobility of ions improve.

The carbonic-acid-ester-based compound is a cyclic carbonic acid ester or a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include ethyl acetate, ethyl propionate, propyl propionate, and ethyl trimethylacetate.

The lactone-based compound is, for example, a lactone. Specific examples of the lactone include γ-butyrolactone and γ-valerolactone.

Note that the ether may be, for example, 1,2-dimethoxyethane, tetrahydrofuran, 1,3-dioxolane, or 1,4-dioxane.

Further, the non-aqueous solvent includes any one or more of solvents including, without limitation, an unsaturated cyclic carbonic acid ester, a fluorinated cyclic carbonic acid ester, a sulfonic acid ester, a phosphoric acid ester, an acid anhydride, a nitrile compound, and an isocyanate compound. One reason for this is that the dissociation property of the electrolyte salt and mobility of ions improve similarly.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

Needless to say, a configuration of the non-aqueous solvent is not particularly limited as long as the non-aqueous solvent includes any one or more of a series of the non-aqueous solvents described above, and may be set as desired.

The electrolyte salt includes any one or more of light metal salts including, without limitation, a lithium salt.

Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl) methide (LiC(CF₃SO₂)₃), lithium bis(oxalato) borate (LiB(C₂O₄)₂), lithium monofluorophosphate (Li₂PFO₃), and lithium difluorophosphate (LiPF₂O₂). One reason for this is that a high battery capacity is obtainable.

A content of the electrolyte salt is not particularly limited, and is specifically within a range from 0.3 mol/kg to 3.0 mol/kg both inclusive with respect to the solvent. One reason for this is that high ion conductivity is obtainable.

As illustrated in FIGS. 1 and 2, the positive electrode lead 31 is a positive electrode wiring coupled to the positive electrode current collector 21A of the positive electrode 21, and is led to an outside of the outer package film 10. The positive electrode lead 31 includes an electrically conductive material such as a metal material. Specific examples of the electrically conductive material include aluminum. The positive electrode lead 31 has any one of shapes including, without limitation, a thin plate shape and a meshed shape.

As illustrated in FIGS. 1 and 2, the negative electrode lead 32 is a negative electrode wiring coupled to the negative electrode 22, and is led to the outside of the outer package film 10. Here, the negative electrode lead 32 is led in a direction similar to a direction in which the positive electrode lead 31 is led. The negative electrode lead 32 includes an electrically conductive material such as a metal material. Specific examples of the electrically conductive material include copper. Note that details of a shape of the negative electrode lead 32 are similar to those of the shape of the positive electrode lead 31.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry of, for example, outside air into the outer package film 10. The sealing film 41 includes a polymer compound such as a polyolefin that has adherence to the positive electrode lead 31. Specific examples of the polymer compound include polypropylene.

A configuration of the sealing film 42 is similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

The secondary battery operates as below in the battery device 20.

Upon discharging, lithium is extracted from the negative electrode 22, and the extracted lithium is inserted into the positive electrode 21 via the electrolytic solution. Upon charging, lithium is extracted from the positive electrode 21, and the extracted lithium is inserted into the negative electrode 22 via the electrolytic solution. Upon each of the charging and the discharging, lithium is inserted and extracted in an ionic state.

When manufacturing the secondary battery, the positive electrode 21 is fabricated and the electrolytic solution is prepared, following which the secondary battery is assembled using the positive electrode 21, the negative electrode 22, and the electrolytic solution and the assembled secondary battery is subjected to a stabilization process, in accordance with an example procedure described below.

First, the positive electrode active material including sulfur, the carbon-nitrogen-containing metal compound, the positive electrode binder, and the positive electrode conductor are mixed with each other to thereby obtain a positive electrode mixture. Thereafter, the positive electrode mixture is put into a solvent to thereby prepare a positive electrode mixture slurry in paste form. The solvent may be an aqueous solvent, or may be an organic solvent. Thereafter, the positive electrode mixture slurry is applied on the two opposed surfaces of the positive electrode current collector 21A to thereby form the positive electrode active material layers 21B. Lastly, the positive electrode active material layers 21B may be compression-molded by means of, for example, a roll pressing machine. In this case, the positive electrode active material layers 21B may be heated. The positive electrode active material layers 21B may be compression-molded multiple times. The positive electrode active material layers 21B are thus formed on the two respective opposed surfaces of the positive electrode current collector 21A. As a result, the positive electrode 21 is fabricated.

The electrolyte salt is put into the solvent. The electrolyte salt is thereby dispersed or dissolved in the solvent. As a result, the electrolytic solution is prepared.

First, the negative electrode 22 including the alkali metal is prepared. In this case, for example, the lithium metal plate is used as the negative electrode 22. Thereafter, the positive electrode lead 31 is coupled to the positive electrode current collector 21A of the positive electrode 21 by a joining method such as a welding method, and the negative electrode lead 32 is coupled to the negative electrode 22 by a joining method such as a welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body (not illustrated). The wound body has a configuration similar to that of the battery device 20 except that the positive electrode 21, the negative electrode 22, and the separator 23 are each not impregnated with the electrolytic solution. Thereafter, the wound body is pressed by means of, for example, a pressing machine to thereby shape the wound body into an elongated shape.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained inside the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by a bonding method such as a thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution, and the battery device 20 that is a wound electrode body is thus formed. Accordingly, the battery device 20 is sealed in the outer package film 10 having the pouch shape. As a result, the secondary battery is assembled.

The assembled secondary battery is charged and discharged. Various conditions including, for example, an environment temperature, the number of times of charging and discharging (the number of cycles), and charging and discharging conditions may be set as desired. As a result, a state of each of the positive electrode 21 and the negative electrode 22 is electrochemically stabilized. As a result, the secondary battery is completed.

According to the secondary battery, the positive electrode 21 includes the positive electrode active material and the carbon-nitrogen-containing metal compound. The positive electrode active material includes sulfur. The carbon-nitrogen-containing metal compound includes carbon, nitrogen, and the metal element as constituent elements.

In this case, as described above, the use efficiency (the coulombic efficiency) of the positive electrode active material (sulfur) improves, as compared with when the positive electrode 21 includes no carbon-nitrogen-containing metal compound, which allows for an improvement in the diffusibility of the electrode reactant (lithium). Accordingly, the diffusibility of lithium is maintained, which reduces a decrease in the battery capacity even upon repeated charging and discharging. Thus, a sufficient battery capacity is obtainable upon repeated use of the secondary battery. As a result, it is possible to achieve a superior battery characteristic.

Note that in a secondary battery in NPTL 1 described above, a mixture ratio (a weight ratio) between sulfur and titanium oxide is set to 70:30. As a result, the energy density per weight of the positive electrode 21 is 400 mAh/g.

In contrast, in the secondary battery of the embodiment, the above-described advantages are achievable even if a mixture ratio (a weight ratio) between sulfur and the carbon-nitrogen-containing metal compound (e.g., zinc cyanamide) is set to 10:1.

Further, in the secondary battery of the embodiment, when each of a current upon discharging and a current upon charging is set to 0.05 C, the energy density per weight of the positive electrode 21 is 556 mAh/g, and when each of the current upon discharging and the current upon charging is set to 0.2 C, the energy density per weight of the positive electrode 21 is 515 mAh/g. Details of the currents (0.05 C and 0.2 C) described here will be described later.

Accordingly, in the secondary battery of the embodiment, unlike the secondary battery in NPTL 1, it is possible to achieve a superior battery characteristic while maintaining the energy density per weight of the positive electrode 21.

In particular, the carbon-nitrogen-containing metal compound may include the metal cyanamide, the metal carbodiimide, or both. This makes it possible to sufficiently improve the coulombic efficiency. Accordingly, it is possible to achieve higher effects. In this case, the metal element may include zinc, calcium, or both. This makes it possible to stably improve the coulombic efficiency. Accordingly, it is possible to further achieve higher effects.

Further, the negative electrode 22 may include the alkali metal. This makes it possible to stably obtain a sufficient battery capacity through insertion and extraction of lithium. Accordingly, it is possible to achieve higher effects. In this case, the alkali metal may include lithium. This makes it possible to further improve the coulombic efficiency. Accordingly, it is possible to achieve further higher effects.

Further, the positive electrode 21 may include the positive electrode conductor, and the positive electrode conductor may include the carbon material. This makes it possible to sufficiently improve the coulombic efficiency. Accordingly, it is possible to achieve higher effects.

Further, the secondary battery may include a lithium-sulfur secondary battery. This makes it possible to stably obtain a sufficient battery capacity through insertion and extraction of lithium. Accordingly, it is possible to achieve higher effects.

In addition, according to the positive electrode 21, the positive electrode 21 includes the positive electrode active material and the carbon-nitrogen-containing metal compound. The positive electrode active material includes sulfur. The carbon-nitrogen-containing metal compound includes carbon, nitrogen, and the metal element as constituent elements. Accordingly, as described above, a decrease in the battery capacity is reduced even upon repeated charging and discharging, owing to an improvement in the coulombic efficiency. As a result, it is possible to provide a secondary battery having a superior battery characteristic.

The configuration of the secondary battery is appropriately modifiable as described below according to an embodiment. Note that any of the following series of modification examples may be combined with each other.

FIG. 3 illustrates a sectional configuration of a secondary battery according toan embodiment. More specifically, FIG. 3 illustrates an enlarged sectional configuration of a positive electrode conductor 212 included in the positive electrode active material layer 21B of the positive electrode 21. In the following, reference is also made to FIG. 2 in addition to FIG. 3 where appropriate.

Here, the positive electrode active material layer 21B includes, as illustrated in FIGS. 2 and 3, a positive electrode active material 211 and the positive electrode conductor 212. Each of the positive electrode active material 211 and the positive electrode conductor 212 is in a form of particles (in powder form). Note that FIG. 3 illustrates only one particle of the positive electrode conductor 212.

The positive electrode conductor 212 includes a carbon material, more specifically includes a carbon material having multiple pores 212K. Specific examples of the carbon material having the multiple pores 212K include activated carbon. Accordingly, the positive electrode conductor 212 has the multiple pores 212K, and the positive electrode active material 211 is disposed in the multiple pores 212K. The positive electrode active material 211 includes sulfur as described above.

In this case, the positive electrode active material 211 may be disposed in a part of the multiple pores 212K, or may be disposed in all of the multiple pores 212K. The positive electrode active material 211 may be present in an entire interior of one pore 212K to thereby fill the interior of the pore 212K, or the positive electrode active material 211 may be present in only a part of the interior of the one pore 212K to thereby allow the interior of the pore 212K to contain the positive electrode material 211 in part.

A procedure for forming the positive electrode conductor 212 having the multiple pores 212K in which the positive electrode active material 211 is disposed is as described below.

First, the positive electrode conductor 212, in powder form, having the multiple pores 212K is disintegrated. In this case, metal balls for disintegration and the positive electrode conductor 212 in powder form are mixed with each other, following which the positive electrode conductor 212 may be subjected to a stirring process with the metal balls. Thereafter, the disintegrated positive electrode conductor 212 is mixed with the positive electrode active material 211 in powder form to thereby obtain a mixture. Lastly, the mixture is heated in an inert atmosphere. In this case, for example, an argon gas is used as an inert gas. Heating conditions including, for example, a heating temperature and a heating time may be set as desired. Thus, the positive electrode active material 211 is disposed in the multiple pores 212K.

In this case, the coulombic efficiency improves, which allows for a further improvement in the diffusibility of lithium. Accordingly, a decrease in the battery capacity is further reduced even upon repeated charging and discharging. As a result, it is possible to achieve higher effects.

The separator 23 that is a porous film is used. However, although not specifically illustrated here, a separator of a stacked type including a polymer compound layer may be used instead of the separator 23 that is the porous film.

Specifically, the separator of the stacked type includes a porous film having two opposed surfaces, and the polymer compound layer provided on one of or each of the two opposed surfaces of the porous film. This improves adherence of the separator to each of the positive electrode 21 and the negative electrode 22, and therefore suppresses misalignment of the battery device 20, that is, winding displacement of each of the positive electrode 21, the negative electrode 22, and the separator. This suppresses swelling of the secondary battery even if a decomposition reaction of the electrolytic solution occurs. The polymer compound layer includes a polymer compound such as polyvinylidene difluoride. One reason for this is that the polymer compound such as polyvinylidene difluoride is superior in physical strength and is electrochemically stable.

Note that the porous film, the polymer compound layer, or both may each include any one or more kinds of insulating particles. One reason for this is that the insulating particles dissipate heat upon heat generation by the secondary battery, thus improving safety or heat resistance of the secondary battery. Examples of the insulating particles include inorganic particles and resin particles. The inorganic particles include any one or more of inorganic materials including, without limitation, aluminum oxide, aluminum nitride, boehmite, silicon oxide, titanium oxide, magnesium oxide, and zirconium oxide. The resin particles include any one or more of resin materials including, without limitation, an acrylic resin and a styrene resin.

When fabricating the separator of the stacked type, a precursor solution including, without limitation, the polymer compound and an organic solvent is prepared, following which the precursor solution is applied on one of or each of the two opposed surfaces of the porous film. In this case, the precursor solution may include the insulating particles.

When the separator of the stacked type is used also, lithium is movable in an ionic state between the positive electrode 21 and the negative electrode 22, and similar effects are therefore achievable. In this case, in particular, the swelling of the secondary battery is further suppressed by suppression of the misalignment of the battery device 20 as described above. Accordingly, it is possible to achieve higher effects.

The electrolytic solution that is a liquid electrolyte is used. However, although not specifically illustrated here, an electrolyte layer that is a gel electrolyte may be used instead of the electrolytic solution.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. One reason for this is that leakage of the electrolytic solution is suppressed. The configuration of the electrolytic solution is as described above. The polymer compound includes, for example, polyvinylidene difluoride. When forming the electrolyte layer, a precursor solution including, without limitation, the electrolytic solution, the polymer compound, and an organic solvent is prepared, following which the precursor solution is applied on one side or both sides of the positive electrode 21 and on one side or both sides of the negative electrode 22.

When the electrolyte layer is used also, lithium is movable in an ionic state between the positive electrode 21 and the negative electrode 22 via the electrolyte layer, and similar effects are therefore achievable. In this case, in particular, the leakage of the electrolytic solution is suppressed, as described above. Accordingly, it is possible to achieve higher effects.

A description is given of applications (application examples) of the secondary battery according to an embodiment.

The applications of the secondary battery are not particularly limited. The secondary battery used as a power source may serve as a main power source or an auxiliary power source in, for example, electronic equipment and an electric vehicle. The main power source is preferentially used regardless of the presence of any other power source. The auxiliary power source may be used in place of the main power source, or may be switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used. The battery pack may include a single battery, or may include an assembled battery. The electric vehicle is a vehicle that travels with the secondary battery as a driving power source, and may be a hybrid automobile that is additionally provided with a driving source other than the secondary battery. In an electric power storage system for home use, electric power accumulated in the secondary battery serving as an electric power storage source may be utilized for using, for example, home appliances.

An application example of the secondary battery will now be described in detail. The configuration described below is merely an example, and is appropriately modifiable.

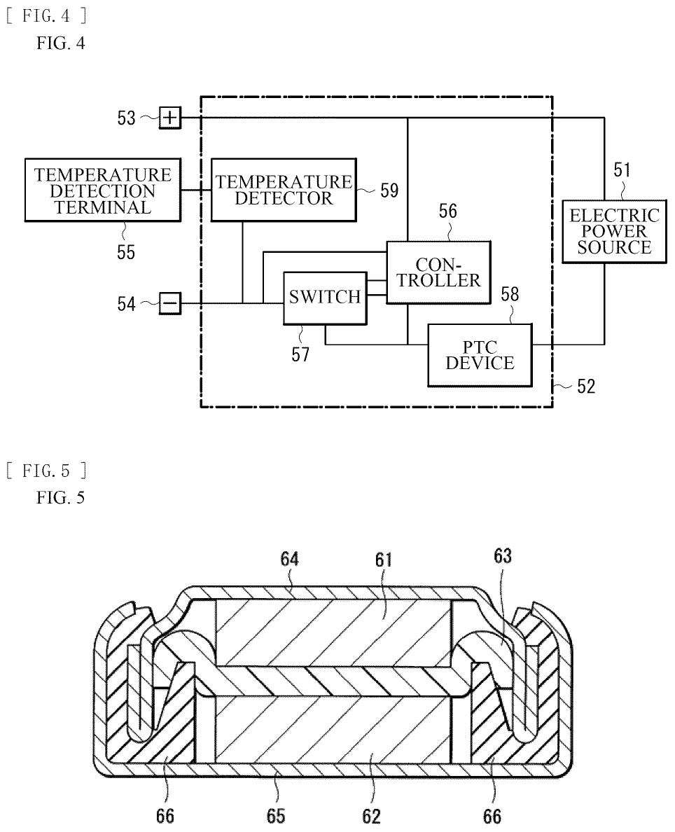

FIG. 4 illustrates a block configuration of a battery pack as the application example of the secondary battery. The battery pack described here is a battery pack (what is called a soft pack) including one secondary battery, and is to be mounted on, for example, electronic equipment typified by a smartphone.

As illustrated in FIG. 4, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a thermosensitive resistive device (what is called a PTC device) 58, and a temperature detector 59. However, the PTC device 58 may be omitted.

The controller 56 includes, for example, a central processing unit (CPU) and a memory, and controls an overall operation of the battery pack. The controller 56 performs, for example, detection and control of a use state of the electric power source 51.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited and is specifically 4.20 V+0.05 V. The overdischarge detection voltage is not particularly limited and is specifically 2.40 V+0.10 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). Each of the charging current and the discharging current is detected based on an ON-resistance of the switch 57.

The temperature detector 59 includes a temperature detection device such as a thermistor. The temperature detector 59 measures a temperature of the electric power source 51 through the temperature detection terminal 55, and outputs a result of the temperature measurement to the controller 56. The result of the temperature measurement to be obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the present technology according to an embodiment.

### Experiment Examples 1 and 2 and Comparative Example 1

Secondary batteries were fabricated, following which the secondary batteries were each evaluated for a battery characteristic as described below.

A secondary battery for testing was fabricated here for simple evaluation. FIG. 5 illustrates a sectional configuration of the secondary battery for testing (a lithium-ion secondary battery of a coin type). In this case, as illustrated in FIG. 3, the positive electrode conductor 212 was used that had the multiple pores 212K in which the positive electrode active material 211 was disposed.

As illustrated in FIG. 5, the secondary battery included a test electrode 61, a counter electrode 62, a separator 63, an outer package cup 64, an outer package can 65, a gasket 66, and an electrolytic solution (not illustrated). Here, the test electrode 61 served as a positive electrode, and the counter electrode 62 served as a negative electrode.

The test electrode 61 was placed inside the outer package cup 64, and the counter electrode 62 was placed inside the outer package can 65. The test electrode 61 and the counter electrode 62 were stacked on each other with the separator 63 interposed therebetween, and the test electrode 61, the counter electrode 62, and the separator 63 were each impregnated with the electrolytic solution. The outer package cup 64 and the outer package can 65 were crimped to each other by means of the gasket 66. Thus, the test electrode 61, the counter electrode 62, and the separator 63 were sealed in the outer package cup 64 and the outer package can 65.

### [Fabrication of Test Electrode (Positive Electrode)]

First, 5 g of the positive electrode conductor 212 in powder form (activated carbon powder), 200 cm³ (=200 cc) of a solvent (pure water), and 500 g of zirconia balls (each having a diameter of 2 mm) were mixed with each other inside a container (having a capacity of 500 cm³ (=500 cc)) to thereby obtain a first mixture. The positive electrode conductor 212 had the multiple pores 212K as described above.

Thereafter, the first mixture was stirred inside the container by means of a stirrer at a stirrer's rotation speed of 150 rpm for a stirring time of 16 hours to thereby disintegrate the positive electrode conductor 212, following which the zirconia balls were collected from the inside of the container. In this case, an average particle size (based on volume) of the disintegrated positive electrode conductor 212 was 0.751 μm.

When measuring the average particle size (based on volume), a laser diffraction/scattering particle size distribution analyzer (particle size distribution) LA-960 available from HORIBA, Ltd. was used as a measuring device. Measurement conditions were as follows: measuring method based on volume; ethanol as a dispersant; and a dispersion condition that ultrasound was applied with an intensity of 5 for 5 minutes.

A pore characteristic of the disintegrated positive electrode conductor 212 (activated carbon) was as follows. Results of a measurement by a BET method were as follows: a specific surface area of 2105 m³/g; a total pore volume (at P/P₀ of 0.990) of 1.64 cm³/g; and a micropore volume (at P/P₀ of 0.2) of 0.89 cm³/g. Results of a measurement by an HK method (micropore analysis (at a pore size of 0 nm to 2 nm both inclusive)) were as follows: a micropore pore volume (Vp) of 0.85 cm³/g; a pore width peak Wpeak (Vol) of 0.61 nm; an average pore width of 0.74 nm; and a cumulative area of 2318 m²/g.

When evaluating the pore characteristic, a specific surface area/pore distribution analyzer BELSORP available from MicrotracBEL Corp. was used as an evaluation device, and evaluation conditions were as follows: a heating temperature of 150° C. and a heating time of 6 hours (under vacuum deaeration); nitrogen gas as an absorption gas; a measurement temperature of 77.36 K; a measurement range being a relative pressure up to 0.200 (P/P₀); of a BET specific surface area having a minimum value determined by selecting a point where linearity was good at an extremely low relative pressure at which a constant C was not a negative value (according to ISO9277 (JIS Z 8830); a BET method at a relative pressure for pore volume calculation (at P/P₀ of 0.200); and a HK method in a calculation range from 0.00 nm to 2.00 nm both inclusive.

Thereafter, the disintegrated first mixture and the positive electrode active material 211 in powder form (sulfur powder) were mixed with each other to thereby obtain a second mixture. In this case, a mixture ratio (a weight ratio) between the disintegrated first mixture and the positive electrode active material 211 was set to 40:60. Thereafter, the second mixture was heated in an inert atmosphere (an argon gas) at a heating temperature of 150° C. for a heating time of 1 hour. Each of interiors of the multiple pores 212K in the positive electrode conductor 212 was filled with the positive electrode active material 211.

Thereafter, the positive electrode conductor 212 having the multiple pores 212K each filled with the positive electrode active material 211, a solvent (pure water), the positive electrode binder (styrene butadiene rubber), an additional positive electrode conductor (acetylene black), and the carbon-nitrogen-containing metal compound were mixed with each other to thereby prepare a positive electrode mixture slurry. In this case, a mixture ratio was so adjusted as to allow a content of the positive electrode active material 211 and a content of the carbon-nitrogen-containing metal compound to be respectively 50.5 wt % and 5 wt % after forming the positive electrode active material layers 21B to be described later (after drying the positive electrode mixture slurry). Used as the carbon-nitrogen-containing metal compound were the metal cyanamide (zinc cyanamide) and the metal carbodiimide (calcium carbodiimide).

Thereafter, the positive electrode mixture slurry was applied on the two opposed surfaces of the positive electrode current collector 21A (an aluminum foil having a thickness of 15 μm) by means of a coating apparatus, following which the applied positive electrode mixture slurry was dried at a drying temperature of 80° C. to thereby form the positive electrode active material layers 21B. In this case, a weight per unit area of the positive electrode active material (sulfur) was set to 1.7 mg/cm².

Lastly, the positive electrode current collector 21A provided with the positive electrode active material layers 21B was punched into a disk shape (having a diameter of 12 mm). The test electrode 61 was thus completed.

Note that the test electrode 61 for comparison was fabricated by a similar procedure except that the carbon-nitrogen-containing metal compound was not included. In this case, the weight per unit area of the positive electrode active material (sulfur) was set to 1.5 mg/cm².

### [Fabrication of Counter Electrode (Negative Electrode)]

An alkali metal (a lithium metal plate) as the negative electrode active material was punched into a disk shape (having a diameter of 16 mm). The counter electrode 62 was thus obtained.

### Preparation of Electrolytic Solution

The electrolyte salt (lithium bis(trifluoromethanesulfonyl)imide) was added to the solvent (vinylene carbonate as the unsaturated cyclic carbonic acid ester and monofluoroethylene carbonate as the fluorinated cyclic carbonic acid ester), following which the solvent was stirred. In this case, a mixture ratio (a volume ratio) between vinylene carbonate and monofluoroethylene carbonate in the solvent was set to 50:50, and the content of the electrolyte salt was set to 1 mol/l (=1 mol/dm³) with respect to the solvent. As a result, the electrolytic solution was prepared.

### [Assembly of Secondary Battery]

First, the test electrode 61 was placed inside the outer package cup 64, and the counter electrode 62 was placed inside the outer package can 65. Thereafter, the test electrode 61 placed inside the outer package cup 64 and the counter electrode 62 placed inside the outer package can 65 were stacked on each other with the separator 63 (a dry separator Celgard 3501 available from Celgard inc.), impregnated with the electrolytic solution, interposed therebetween. Lastly, the outer package cup 64 and the outer package can 65 were crimped to each other by means of the gasket 66 in a state where the test electrode 61 and the counter electrode 62 were stacked on each other with the separator 63 interposed therebetween. Accordingly, the test electrode 61 and the counter electrode 62 were sealed in the outer package cup 64 and the outer package can 65. As a result, the secondary battery was assembled.

### [Stabilization of Secondary Battery]

The secondary battery was charged and discharged for three cycles in an ambient temperature environment (at a temperature of 25° C.). In this case, upon discharging, the secondary battery was discharged with a constant current of 0.05 C until a voltage reached 1.0 V, and upon charging, the secondary battery was charged with a constant current of 0.05 C until the voltage reached 3.0 V. Note that 0.05 C was a value of a current that caused a battery capacity (a theoretical capacity) to be completely discharged in 20 hours.

Thus, a state of each of the test electrode 61 and the counter electrode 62 was electrochemically stabilized. As a result, the secondary battery was completed.

### [Evaluation of Battery Characteristic]

Evaluation of the secondary batteries for a charge and discharge characteristic and a cyclability characteristic as the battery characteristic revealed the results presented in Table 1.

### [Charge and Discharge Characteristic]

First, the secondary battery was charged and discharged for 30 cycles in an ambient temperature environment (at a temperature of 25° C.) to thereby measure a 30th-cycle discharge capacity and a 30th-cycle charge capacity. Charging and discharging conditions were similar to the charging and discharging conditions for the stabilization of the secondary battery, except that the current upon discharging was changed to 0.2 C and the current upon charging was changed to 0.2 C. Note that 0.2 C was a value of a current that caused the battery capacity to be completely discharged in 5 hours.

Thus, the coulombic efficiency as an index for evaluating the charge and discharge characteristic was calculated based on the following calculation expression: coulombic efficiency (%)=(30th-cycle charge capacity/30th-cycle discharge capacity)× 100.

### [Cyclability Characteristic]

First, the secondary battery was charged and discharged in an ambient temperature environment (at a temperature of 25° C.) to thereby measure the discharge capacity (a first-cycle discharge capacity). Thereafter, the secondary battery was repeatedly charged and discharged in the same environment until the number of cycles reached 30 to thereby measure the discharge capacity (a 30th-cycle discharge capacity). Note that charging and discharging conditions were similar to the charging and discharging conditions for evaluation of the charge and discharge characteristic.

Thus, a capacity retention rate as an index for evaluating the cyclability characteristic was calculated based on the following calculation expression: capacity retention rate (%)=(30th-cycle discharge capacity/first-cycle discharge capacity)×100.

TABLE 1

| | | | | Negative | | |
|---|---|---|---|---|---|---|
| | Positive electrode | | | electrode | | |
| | Positive | | | Negative | | |
| | electrode | Carbon-nitrogen- | Positive | electrode | Coulombic | Capacity |
| | active | containing metal | electrode | active | efficiency | retention |
| | material | compound | conductor | material | (%) | rate (%) |
| Example 1 | Sulfur | Zinc cyanamide | Activated | Lithium | 99.5 | 98.5 |
| | | | carbon | | | |
| Example 2 | Sulfur | Calcium | Activated | Lithium | 99.4 | 77.9 |
| | | carbodiimide | carbon | | | |
| Comparative | Sulfur | — | Activated | Lithium | 98.9 | 69.3 |
| example 1 | | | carbon | | | |

As indicated in Table 1, the coulombic efficiency and the cyclability retention rate each varied greatly depending on the configuration of the positive electrode 21.

Specifically, when the positive electrode active material layer 21B included the carbon-nitrogen-containing metal compound (Examples 1 and 2), the coulombic efficiency increased and the capacity retention rate also increased, as compared with when the positive electrode active material layer 21B included no carbon-nitrogen-containing metal compound.

In particular, when the positive electrode active material layer 21B included the carbon-nitrogen-containing metal compound, the following tendencies were obtained. Firstly, both when the metal cyanamide was used as the carbon-nitrogen-containing metal compound and when the metal carbodiimide was used as the carbon-nitrogen-containing metal compound, high coulombic efficiency was obtained and a high capacity retention rate was also obtained. Secondly, when the positive electrode active material layer 21B included the positive electrode conductor 212 having the multiple pores 212K and the positive electrode active material 211 was disposed in the multiple pores 212K, high coulombic efficiency was obtained and a high capacity retention rate was also obtained.

Based upon the results presented in Table 1, when: the positive electrode 21 included the positive electrode active material and the carbon-nitrogen-containing metal compound; the positive electrode active material included sulfur; and the carbon-nitrogen-containing metal compound included carbon, nitrogen, and the metal element as constituent elements, the charge and discharge characteristic and the cyclability characteristic each improved. Accordingly, it was possible to achieve a superior battery characteristic of the secondary battery.

Although the present technology has been described above with reference to one or embodiments including Examples, the configuration of the present technology is not limited thereto, and is therefore modifiable in a variety of ways.

For example, the description has been given of the case where the secondary battery has a battery structure of the laminated-film type or the coin type. However, the device structure of the secondary battery is not particularly limited, and may be, for example, of a cylindrical type, a prismatic type, or a button type.

Further, the description has been given of the case where the battery device has a device structure of a wound type. However, the device structure of the battery device is not particularly limited, and the device structure may be, for example, a stacked type or a zigzag folded type. In the stacked type, the positive electrode and the negative electrode are stacked on each other. In the zigzag folded type, the positive electrode and the negative electrode are folded in a zigzag manner.

Further, although the description has been given of the case where the electrode reactant is lithium, the electrode reactant is not particularly limited. For example, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other effect.

Note that the present technology may have the following configurations according to an embodiment.

<1>

A secondary battery including:
a positive electrode;
a negative electrode; and
an electrolytic solution, in which
the positive electrode includes a positive electrode active material and a carbon-nitrogen-containing metal compound,
the positive electrode active material includes sulfur, and
the carbon-nitrogen-containing metal compound includes carbon, nitrogen, and a metal element as constituent elements.
   <2>

The secondary battery according to <1>, in which the carbon-nitrogen-containing metal compound includes a metal cyanamide, a metal carbodiimide, or both.

<3>

The secondary battery according to <2>, in which the metal element includes zinc, calcium, or both.

<4>

The secondary battery according to any one of <1> to <3>, in which
the negative electrode includes a negative electrode active material, and
the negative electrode active material includes an alkali metal.
   <5>

The secondary battery according to <4>, in which the alkali metal includes lithium.

<6>

The secondary battery according to any one of <1> to <5>, in which
the positive electrode further includes a positive electrode conductor, and
the positive electrode conductor includes a carbon material.
   <7>

The secondary battery according to <6>, in which
the positive electrode conductor has multiple pores, and
the positive electrode active material is disposed in the multiple pores.
   <8>

The secondary battery according to any one of <1> to <7>, in which the secondary battery includes a lithium-sulfur secondary battery.

<9>

An electrode for a secondary battery, the electrode including:
a positive electrode active material; and
a carbon-nitrogen-containing metal compound, in which
the positive electrode active material includes sulfur, and
the carbon-nitrogen-containing metal compound includes carbon, nitrogen, and a metal element as constituent elements.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode; and
an electrolytic solution, wherein
the positive electrode includes a positive electrode active material and a carbon-nitrogen-containing metal compound,
the positive electrode active material includes sulfur, and
the carbon-nitrogen-containing metal compound includes carbon, nitrogen, and a metal element as constituent elements.

2. The secondary battery according to claim 1, wherein the carbon-nitrogen-containing metal compound includes a metal cyanamide, a metal carbodiimide, or both.

3. The secondary battery according to claim 2, wherein the metal element includes zinc, calcium, or both.

4. The secondary battery according to claim 1, wherein
the negative electrode includes a negative electrode active material, and
the negative electrode active material includes an alkali metal.

5. The secondary battery according to claim 4, wherein the alkali metal includes lithium.

6. The secondary battery according to claim 1, wherein
the positive electrode further includes a positive electrode conductor, and
the positive electrode conductor includes a carbon material.

7. The secondary battery according to claim 6, wherein
the positive electrode conductor has multiple pores, and
the positive electrode active material is disposed in the multiple pores.

8. The secondary battery according to claim 1, wherein the secondary battery comprises a lithium-sulfur secondary battery.

9. An electrode for a secondary battery, the electrode comprising:
a positive electrode active material; and
a carbon-nitrogen-containing metal compound, wherein
the positive electrode active material includes sulfur, and
the carbon-nitrogen-containing metal compound includes carbon, nitrogen, and a metal element as constituent elements.
